(19) United States
(12) Patent Application Publication
(10) Pub. No.: US 2016/0253141 A1
(43) Pub. Date: Sep. 1, 2016

(54) Wearable Device with Data Privacy Display

(71) Applicant: Plantronics, Inc., Santa Cruz, CA (US)

(72) Inventors: Shantanu Sarkar, San Jose, CA (US); Timothy P. Johnston, Los Gatos, CA (US); Cary Bran, Seattle, WA (US); Joe Burton, Los Gatos, CA (US); Douglas K. Rosener, Santa Cruz, CA (US); Bowman Wang, Ben Lomond, CA (US)

(73) Assignee: Plantronics, Inc., Santa Cruz, CA (US)

(21) Appl. No.: 14/634,001

(22) Filed: Feb. 27, 2015

(51) Int. Cl. G06F 3/14; G06F 21/62; G06F 3/01; G06F 1/16

(52) U.S. Cl. CPC G06F 3/1423; G06F 1/163; G06F 21/6245; G06F 3/011

(57) ABSTRACT

Methods and apparatuses for displaying private data are disclosed. In one example, data is identified as a private data type or a public data type. The data is output on an arm wearable device first display responsive to identifying the data as the private data type, the first display arranged to display a private data. The data is output on an arm wearable device second display responsive to identifying the data as the public data type, the second display arranged to display a public data.

### BACKGROUND OF THE INVENTION

Wrist-worn devices typically have a single display that is worn on top of the wearer's wrist. In the prior art, wrist-worn devices generally only provided time and date information. However, as wrist-worn devices offer increased functionality to display a variety of data, privacy concerns arise. Because the display is on the top of the wrist, the displayed information is often visible to others. This is undesirable for information the wearer considers private. For example, such private information may include data related to user authentication, such as personal identification numbers. As a result, improved methods and apparatuses for displaying private data are needed.

### BRIEF DESCRIPTION OF THE DRAWINGS

The present invention will be readily understood by the following detailed description in conjunction with the accompanying drawings, wherein like reference numerals designate like structural elements.

FIG. 1A illustrates a perspective view of a wrist-worn apparatus in one example.

FIG. 1B illustrates a side view of the wrist-worn apparatus shown in FIG. 1A.

FIG. 2 illustrates a wrist-worn apparatus in a further example.

FIG. 3 illustrates a use scenario of the wrist worn apparatus shown in FIG. 2.

FIG. 4 illustrates a use scenario of the wrist worn apparatus shown in FIG. 2.

FIG. 5 illustrates a simplified block diagram of the wrist worn apparatus shown in FIG. 1 or FIG. 2.

FIG. 6 illustrates a system for displaying private and public data at a wrist worn apparatus in one use scenario.

FIG. 7 is a flow diagram illustrating displaying data at a wrist-worn apparatus in one example.

FIG. 8 is a flow diagram illustrating displaying data at a wrist-worn apparatus in a further example.

FIG. 9 illustrates a geofencing use scenario of the wrist worn apparatus.

### DESCRIPTION OF SPECIFIC EMBODIMENTS

Methods and apparatuses for display of private data are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein.

Block diagrams of example systems are illustrated and described for purposes of explanation. The functionality that is described as being performed by a single system component may be performed by multiple components. Similarly, a single component may be configured to perform functionality that is described as being performed by multiple components. For purpose of clarity, details relating to technical material that is known in the technical fields related to the invention have not been described in detail so as not to unnecessarily obscure the present invention. It is to be understood that various example of the invention, although different, are not necessarily mutually exclusive. Thus, a particular feature, characteristic, or structure described in one example embodiment may be included within other embodiments unless otherwise noted.

In one example, an arm wearable device includes a first display screen arranged to display private data, a second display screen arranged to display public data, and a processor. The arm wearable device includes a memory storing an application program executable by the processor, the application program configured to identify a data as a private data type or a public data type. The application program is further configured to display the data on the first display screen if the data is the private data type or display the data on the second display screen if the data is the public data type.

In one example, an arm wearable device includes a sensor to output a sensor data comprising a motion data or an orientation data, a display, and a processor. The arm wearable device includes a memory storing an application program executable by the processor, the application program configured to process the sensor data identify a user action indicating a user desire to view a private data. The application program is further configured to display the private data at the display responsive to identification of the user desire to view the private data.

In one example, a method includes identifying a data as a private data type or a public data type. The method includes outputting the data on an arm wearable device first display responsive to identifying the data as the private data type, the first display arranged to display a private data. The method includes outputting the data on an arm wearable device second display responsive to identifying the data as the public data type, the second display arranged to display a public data.

In one example, a method includes receiving a sensor data associated with a motion or orientation of a user arm, and processing the sensor data to identify a user action indicating a user desire to view a private data. The method includes displaying the private data on a display of an arm wearable device responsive to the user action indicating the user desire to view the private data.

In one example, the dorsal side of a wrist-worn device is used for public data and the underside of the wearer wrist is used for private data. In one example, display of data is tied to geofencing authorized locations and proximity to potential eavesdroppers to suppress some data display—public and private data both. For example, out of band sonar is utilized to detect if someone else is close to the wearer, and the wrist-worn device responds accordingly if a potential eavesdropper is present. In one embodiment, a 25 KHz MEMS microphone and a signal generator are utilized to implement the out of band sonar proximity detection. In one example of a single display wrist-worn device, a wrist flip or custom gesture is utilized to activate a notification screen. User authentication is then required to validate the gesture. Any user authentication technique may be utilized, including entry of a user password or personal identification number, or biometric authentication techniques.

In one example, the invention uses two techniques to improve wrist displays. First it has two displays instead of a single display, one on the top of the wrist and one on the bottom of the wrist. If desired, public information can appear on top of the wrist, and more private information can appear on the bottom of the wrist. This addresses the problem of data privacy. It also solves the problem of display space limitations since two pieces of information can appear simultaneously requiring the user only to twist the wrist to view both at the same time. Second, the wrist worn apparatus uses an inertial measurement system including an accelerometer to detect the orientation of the wrist. The orientation can control what is displayed. This can solve the privacy problem, even in single display devices. For example, when the wrist is held in the horizontal position with top of wrist facing up, normal public information can be displayed (if desired on the top display). When held vertically, private information can be displayed (if desired, on the bottom display). In all other positions the display can be turned off. Furthermore, advantageously, the use of dual display screens in one example allows the wearer to see two pieces of information simultaneously. This obviates the need to switch back and forth between the two pieces of information, as is required by single display devices.

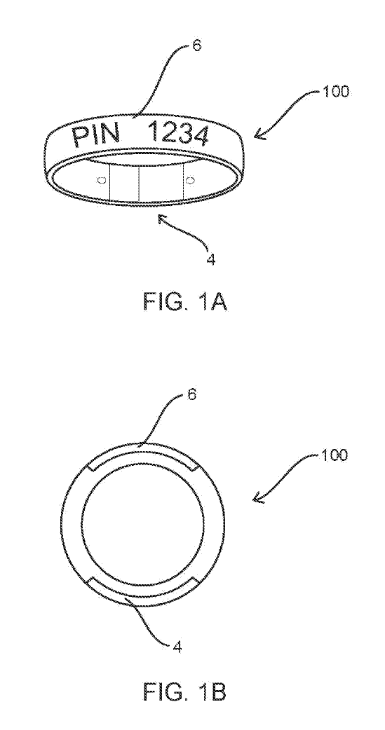

FIG. 1A illustrates an arm worn apparatus in one example. In the example shown in FIG. 1A, a perspective view of a wrist-worn apparatus 100 in a bracelet form factor is shown. FIG. 1B illustrates a side view of the wrist-worn apparatus 100 shown in FIG. 1A. In one example, the wrist-worn apparatus 100 includes a first display 6 arranged to display private data, a second display 4 arranged to display public data, and a processor. The wrist-worn apparatus 100 includes a memory storing an application program executable by the processor to identify a data to be displayed to the wearer of wrist-worn apparatus 100 as a private data type or a public data type. The application program is further configured to display the data on the first display 6 if the data is the private data type or display the data on the second display 4 if the data is the public data type.

In one example, the wrist-worn apparatus 100 includes a sensor to output a sensor data comprising a motion data or an orientation data. The wrist-worn apparatus 100 includes a memory storing an application program executable by the processor to process the sensor data identify a user action indicating a user desire to view a private data. The application program is further configured to display the private data at either the display 4 or display 6 responsive to identification of the user desire to view the private data. In one embodiment of this example, only a single display 4 or display 6 is included at wrist-worn apparatus 100.

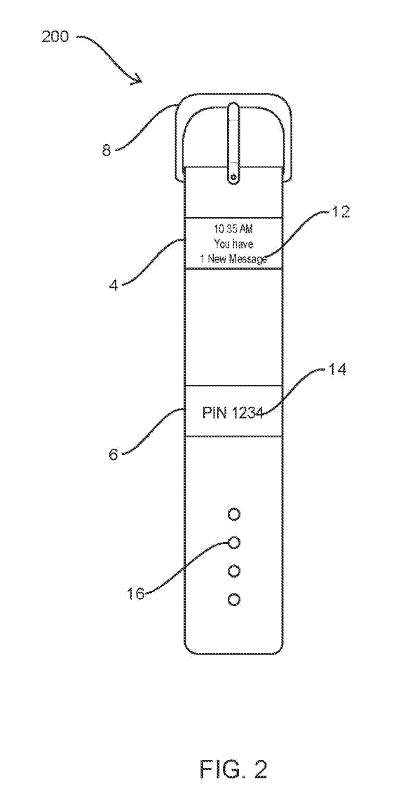

FIG. 2 illustrates an arm worn apparatus in a further example. In the example shown in FIG. 2, a top view of a wrist-worn apparatus 200 in a wrist-watch form factor is shown. Wrist-worn apparatus 200 includes a clasp mechanism 8 and clasp mechanism 10 for securing wrist-worn apparatus 200 on a user wrist. Although a traditional buckle mechanism is shown, any type of clasp mechanism may be utilized. For example, additional mechanisms include fold over clasps, bangle bracelets, and deployment buckles.

In one example, the wrist-worn apparatus 200 includes a first display 6 arranged to display private data 14, a second display 4 arranged to display public data 12, and a processor. The wrist-worn apparatus 200 includes a memory storing an application program executable by the processor to identify a data to be displayed to the wearer of wrist-worn apparatus 200 as a private data type or a public data type. The application program is further configured to display the data on the first display 6 if the data is the private data type or display the data on the second display 4 if the data is the public data type. For example, as shown in FIG. 2, private data 14 may be a user personal identification number (PIN). In further examples, private data 14 may include messages from certain specified contacts, or application specific access codes. Public data 12 may include, for example, whether the user has received a new message. In one example, what constitutes private data 14 or public data 12 is designated by the user for a given application program being executed on wrist-worn apparatus 200 or any device in communication with wrist-worn apparatus 200. In one example, what constitutes private data 14 or public data 12 is designated by the application program being executed on wrist-worn apparatus 200 or any device in communication with wrist-worn apparatus 200. In one example, public data 12 is any data which is not designated as private data 14.

In one example, display 6 and display 4 are discrete display devices integrated with the band of wrist-worn apparatus 200. In a further example, a single display running the length of wrist-worn apparatus 200 is utilized, whereby certain areas of the display are utilized to display private data and certain areas of the display are utilized to display public data.

In one example, the wrist-worn apparatus 200 includes a sensor to output a sensor data comprising a motion data or an orientation data. The wrist-worn apparatus 200 includes a memory storing an application program executable by the processor to process the sensor data identify a user action indicating a user desire to view a private data 14. The application program is further configured to display the private data 14 at either the display 4 or display 6 responsive to identification of the user desire to view the private data 14. In one embodiment of this example, only a single display 4 or display 6 is included at wrist-worn apparatus 200.

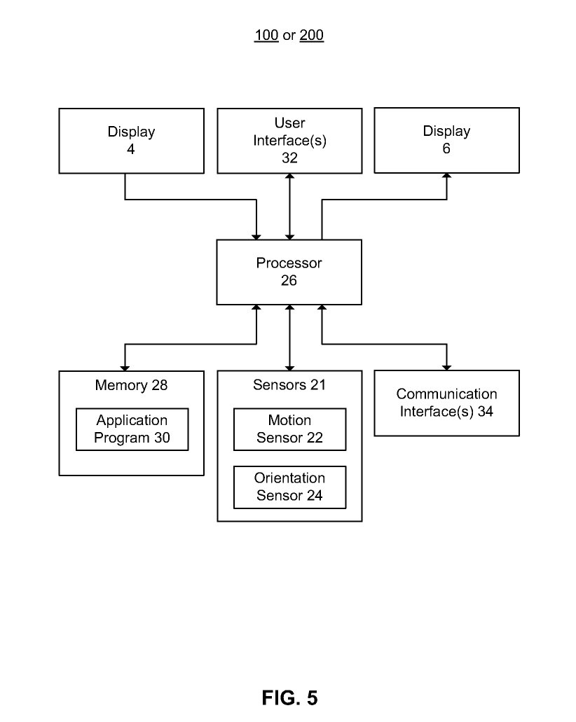

FIG. 5 illustrates a simplified block diagram of the wrist worn apparatus 100 shown in FIG. 1 or the wrist worn apparatus 200 shown FIG. 2 configured to implement one or more examples described herein. The term “wrist worn apparatus” as used herein encompasses any wrist-worn device operable as described herein.

In one example, a wrist worn apparatus 200 includes a display 4, display 6, user interface(s) 32, a memory 28, and communication interface(s) 34. Display 4 and display 6 may, for example, be pixelated display screens capable of displaying text and graphics. Display 4 and display 6 may, for example, be touch input displays, flexible displays, or curved displays.

In one example, communication interface(s) 34 are a wireless transceiver and a wired network interface. User interface(s) 32 may include various means to receive user actions to operate the wrist worn apparatus 200, such as buttons or keys, or capacitive touch sensors. Input buttons may include, for example, on/off buttons or arrow keys. The user interface(s) 32 may also include one or more additional output interfaces, such as LED indicators, in addition to display 4 and display 6. Wrist worn apparatus 200 may include a microphone for detecting sound, a speaker for outputting sound, and associated analog-to-digital and digital-to-analog converters. Wrist worn apparatus 200 may include one or more sensors 21. Sensors 21 may include a motion sensor 22 and an orientation sensor 24. Motion sensor 22 can provide information which can be used to interpret human movement as a gesture. For example, the motion sensor 22 may be an InvenSense™ 9150 module capable of 9-axis motion tracking and including accelerometers, a gyroscope, and a compass. In one example, the wrist worn apparatus 200 processes the sensor data to identify a user action, and performs a display action responsive to the user action. For example, the sensor data may be motion, position, or orientation data associated with a user wrist or arm.

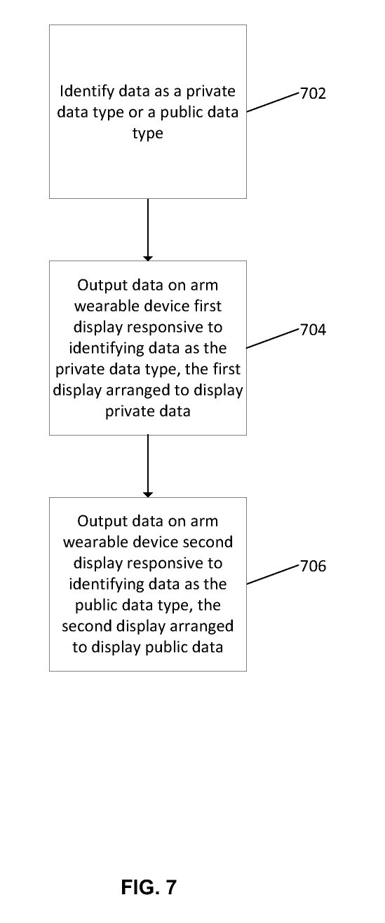

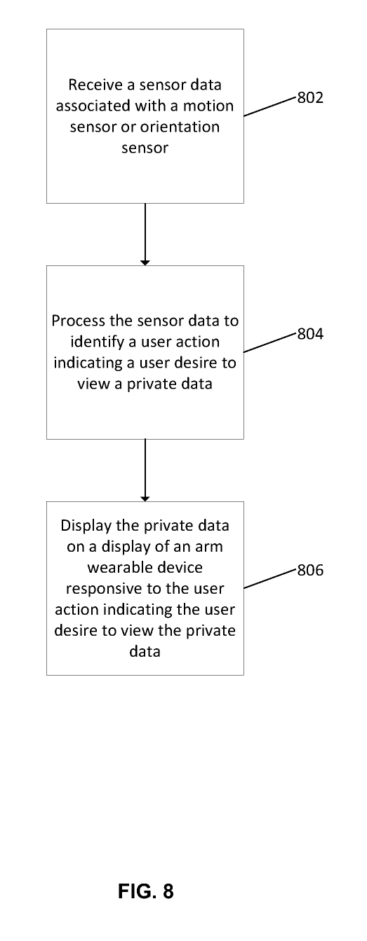

Memory 28 represents an article that is computer readable. For example, memory 28 may be any one or more of the following: random access memory (RAM), read only memory (ROM), flash memory, or any other type of article that includes a medium readable by processor 26. Memory 28 can store computer readable instructions for performing the execution of the various method embodiments of the present invention. In one example, the processor executable computer readable instructions are configured to perform part or all of a process such as that shown in FIGS. 7-8. Computer readable instructions may be loaded in memory 28 for execution by processor 26.

Communication interface(s) 34 allows wrist worn apparatus 200 to communicate with other devices. Communication interface(s) 34 may include, but are not limited to, a wireless transceiver, an integrated network interface, a radio frequency transmitter/receiver, a USB connection, or other interfaces for connecting wrist worn apparatus 200 to a telecommunications network such as a Bluetooth network, an IEEE 802.11 (WiFi) network, cellular network, the PSTN, or an IP network in various non-limiting examples.

In one example operation, the wrist worn apparatus 200 includes a processor 26 configured to execute one or more applications and operate the wrist worn apparatus 200 to receive, collect, process, and display data. In one example, the processor 26 is further configured to detect whether the wrist worn apparatus 200 is worn or not worn on a user wrist.

In one example, the one or more applications are configured to detect a user wrist or forearm orientation. For example, the user wrist or forearm orientation is along an x-axis direction, y-axis direction, or z-axis direction, where the x-axis is across the user body (i.e., from left to right), the y-axis is away from the user body (i.e., from front to back), and the z-axis is perpendicular to the ground (i.e., from toe to head). In a further example, the user wrist or forearm orientation is a forearm ventral side facing the user or a forearm dorsal side facing the user. In one example, the one or more applications are configured to process the sensor data to determine a user arm motion flipping the user forearm from the ventral side facing the user to the dorsal side facing the user, or vice versa. In one example, the one or more applications are configured to activate or deactivate one or more system components responsive to the sensor data.

In one embodiment, display 6 is arranged to display private data and display 4 is arranged to display public data. For example, the display 6 is arranged to be worn on a bottom side of a user wrist (i.e., ventral side) and the display 4 is arranged to be worn on a top side (i.e., dorsal side) of the user wrist. Application program 30 executable by the processor 26 is configured to identify a data as a private data type or a public data type. Application program 30 is further configured to display the data on the display 6 if the data is the private data type or display the data on the display 4 if the data is the public data type.

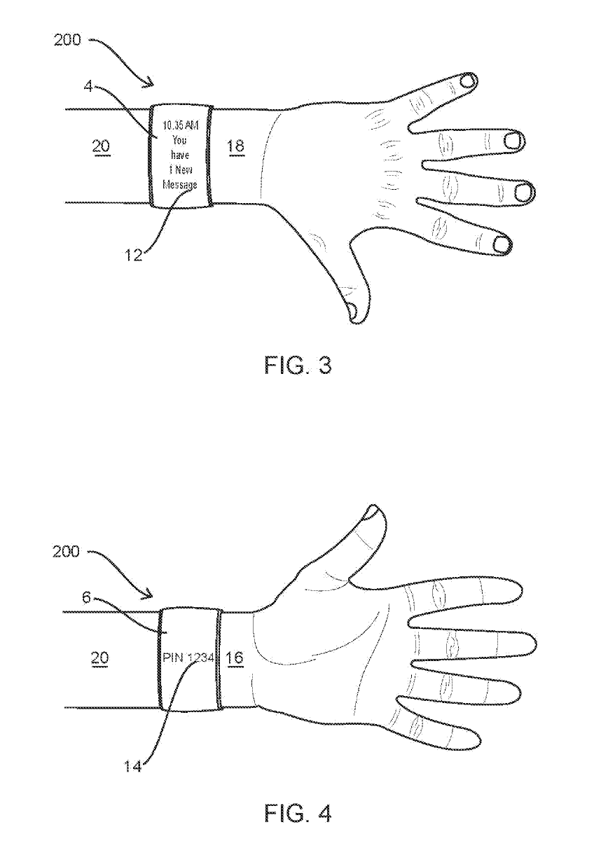

FIG. 3 illustrates a use scenario of the wrist worn apparatus 200 shown in FIG. 2. Illustrated in FIG. 3 is a user left hand positioned so that the dorsal side 18 of the user forearm 20 and hand (palm down) is facing the user. Display 4 showing public data 12 is visible to the user when the wrist dorsal side 18 is facing the user. FIG. 4 illustrates a use scenario of the wrist worn apparatus 200 shown in FIG. 2. Illustrated in FIG. 4 is a user left hand positioned so that the ventral side 16 of the user forearm 20 and hand (palm up) is facing the user. Display 6 showing private data 14 is visible to the user when the wrist ventral side 16 is facing the user.

In one embodiment, the application program 30 is configured to process the motion sensor data from motion sensor 22 to identify a user action indicating a user desire to view a private data. The application program 30 is configured to display the private data at the display 6 responsive to identification of the user desire to view the private data. For example, the user action is to position a user forearm 20 vertically. In a further example, the user action is to flip a user wrist so that the ventral side 16 of the user wrist is facing upwards instead of downwards.

In one embodiment, orientation sensor(s) 24 are configured to output a sensor data capable of being processed to detect a user wrist or forearm orientation. Application program 30 is configured to determine whether or where data which is a private data type is displayed based on detection of the user wrist or forearm orientation. For example, application program 30 displays private data if it detects the forearm ventral side is facing the user.

In one embodiment, wrist worn apparatus 200 further includes a proximity detection system to detect a proximity of a person to a wearer of the wrist worn apparatus 200. The application program 30 is configured to determine whether or where data which is a private data type is displayed based on an output of the proximity detection system. For example, wrist worn apparatus 200 includes an acoustic transducer configured to generate an acoustic wave external to the earpiece, an acoustic sensor, and a speaker. The processor of the wrist worn apparatus 200 is configured to cause the wrist-worn apparatus 200 to control the display of private data responsive to the acoustic sensor receiving a reflection of the acoustic wave.

In one example operation, the wrist worn apparatus 200 may control whether and where private data is displayed responsive to detecting nearby people. The acoustic transducer may generate an acoustic wave. For example, the acoustic transducer may generate an ultrasonic signal. The acoustic wave may take any form, such as tones, chirps or the like. If the acoustic sensor receives a reflection of the acoustic wave, then the processor 26 processes the reflection. Processor 26 generates one or more parameters based on data generated by the acoustic sensor which represents the reflection. The examples presented now are intended to be illustrative, not limiting. The processor 26 may determine a distance to a reflector of the acoustic wave based on an elapsed time between transmitting the acoustic wave and receiving the corresponding reflection. The processor 26 may determine a closing velocity and/or closing acceleration of the reflector using Doppler techniques or the like. In implementations having more than one acoustic sensor, the processor may determine a direction of the reflector using time difference of arrival techniques or the like. The processor 26 may determine other parameters instead of, or in addition to, the examples listed above. The processor 26 may employ data provided by the sensors 21 in determining these and other parameters. For example, the processor may employ the accelerometer data to compensate for motion of the wrist worn apparatus 200 (i.e., the motion of the user).

The processor 26 may determine whether the determined parameters meet selected criteria. If the criteria are met, the processor 26 may cause the wrist worn apparatus 200 to suppress display of private data at display 4 or display 6 until the wearer performs a certain pre-defined user gesture. For example, the criteria may specify that display of the private data should be suppressed when the reflector is within five feet of the wrist worn apparatus 200 or is approaching the wrist worn apparatus 200 at a speed exceeding 2 miles per hour. In addition to suppressing display of the private data, an alert may be output at user interface(s) 32. The wrist worn apparatus 200 may provide the alert in any manner. In some embodiments, the alert may differ based on the location or activity of the user.

In a further example operation, the wrist worn apparatus 200 may control whether and where private data is displayed responsive to detecting speech of persons other than the wearer. A microphone at wrist worn apparatus may receive sound. The processor 26 may process the sound. If the sound represents speech, the processor 26 may cause the wrist worn apparatus 200 to provide an alert.

The processor 26 may detect speech in the sound in any manner. For example, the processor 26 may require a certain sound pressure in a certain amount in a certain band for a certain time (e.g., 60 db between 800 Hz and 2 KHz for 300 ms). The processor 26 may cause the wrist worn apparatus 200 to suppress the display of private data only when the speech is that of a person other than the wearer. The processor 26 may determine the speech is that of a person other than the wearer in any manner. For example, the processor 26 may employ characteristics of the audio such as amplitude, techniques such as near/far detection, and the like to distinguish speech of the wearer from speech of others. For example, in a wrist worn apparatus 200 having multiple microphones, detecting sound in the speech band with significantly higher sound pressure on one of the microphones may indicate a person to one side of the wearer.

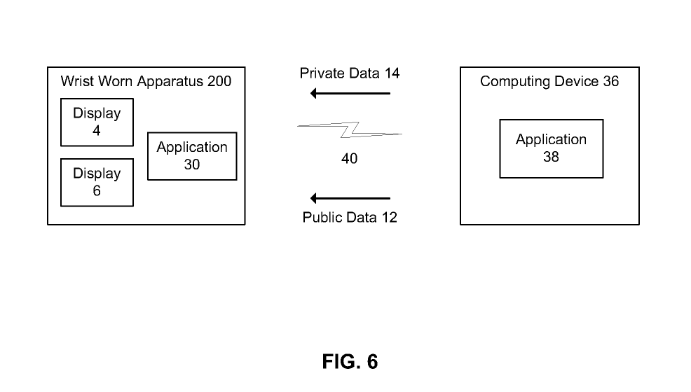

In other embodiments, some of the functions performed by the wrist worn apparatus 200 may be performed by the computing device 36 shown in FIG. 6. The communication interface(s) 34 of the wrist worn apparatus 200 may transmit raw data to a transceiver of the computing device 36. The processor of the computing device 36 may determine the parameters based on the raw data. The computing device 36 may transfer the parameters to the wrist worn apparatus 200. Methods and systems for proximity detection of nearby persons are discussed in co-pending and commonly assigned U.S. patent application Ser. No. 14/298,754 for “Audio Headset for Alerting User to Nearby People and Objects” filed on Jun. 6, 2014, which is hereby incorporated by reference in its entirety for all purposes.

In one embodiment, wrist worn apparatus 200 further includes a location detection system to determine a location of the wrist worn apparatus 200. The application program 30 is configured to determine whether or where data which is a private data type is displayed based on the location of the wrist worn apparatus 200. Wrist worn apparatus 200 includes a location services application to identify a current location of wrist worn apparatus 200. In one example, the location of the wrist worn apparatus 200 may be continuously monitored or monitored periodically as needed. In one example, wrist worn apparatus 200 utilizes the Android operating system. The location services application utilizes location services offered by the Android device (global positioning system (GPS), WiFi, and cellular network) to determine and log the location of the wrist worn apparatus 200.

For example, wrist worn apparatus 200 includes a GPS receiver for use by location services application. The GPS receiver has an antenna to receive GPS information, including location information to indicate to the wrist worn apparatus 200 where it is geographically located. In further examples, one or more of GPS, WiFi, or cellular network may be utilized to determine location. In certain cases, the GPS may not be able to provide a location if a satellite signal is blocked or obstructed. The cellular network may be used to determine the location of wrist worn apparatus 200 utilizing cellular triangulation methods.

In one example, a Google Maps API is used which utilizes an Android phone's “location services” to compute the map location of the wrist worn apparatus 200. These services consist of two options: GPS and Network (Cell Phone Location and Wi-Fi). The best source from whichever service is turned on and providing data is utilized. The combination of data supplied by one or more of the primary three location services (GPS, WiFi, and cell network) provide a high level of location accuracy.

FIG. 6 illustrates a system for displaying private and public data at a wrist worn apparatus in one use scenario. In the system shown in FIG. 6, wrist worn apparatus 200 is in wireless communication with a computing device 36 via wireless communications link 40. Computing device 36 executes an application 38. For example, computing device 36 may be a smartphone, laptop computer, or personal computer. In one example, computing device 36 is capable of communications with one or more communication network(s). For example, the communication network(s) may include an Internet Protocol (IP) network, cellular communications network, public switched telephone network, IEEE 802.11 wireless network, or any combination thereof.

In one example operation, wrist worn apparatus 200 receives public data 12, private data 14, or a combination of public data 12 and private data 14 from computing device 36. Computing device 36 may execute a variety of applications producing public data 12 or private data 14 to be sent to wrist worn apparatus 200 over link 40 for display. In one example, wrist worn apparatus 200 operates as described above in reference to FIG. 5 following receipt of data from computing device 36.

FIG. 7 is a flow diagram illustrating displaying data at a wrist-worn apparatus in one example. At block 702, data is identified as a private data type or a public data type. At block 704, the data is output on an arm wearable device first display responsive to identifying the data as the private data type, the first display arranged to display a private data.

At block 706, data is output on an arm wearable device second display responsive to identifying the data as the public data type, the second display arranged to display a public data. In one example, the first display is arranged to be worn on a bottom side of a user wrist and the second display is arranged to be worn on a top side of the user wrist.

In one example, the process further includes receiving sensor data from one or more sensors, the one or more sensors including a motion sensor to output a motion sensor data. A user action is identified from the motion sensor data indicating a user desire to view a private data, and the private data is displayed at the first display screen responsive to the user desire to view the private data. In one example, the user action is to position a user forearm vertically. In a further example, the user action is to flip a user wrist so that the bottom side of the user wrist is facing upwards instead of downwards.

In one example, the process further includes receiving sensor data to detect a user wrist or forearm orientation. It is determined whether or where data which is a private data type is displayed based on detection of the user wrist or forearm orientation.

In one example, the process further includes detecting a proximity of a person to a wearer of the arm wearable device. It is determined whether or where data which is a private data type is displayed based on the proximity of the person. In one example, the process further includes determining a location of the arm wearable device. It is determined whether or where data which is a private data type is displayed based on the location of the arm wearable device.

FIG. 8 is a flow diagram illustrating displaying data at a wrist-worn apparatus in a further example. At block 802, sensor data is received associated with a motion or orientation of a user arm.

At block 804, the sensor data is processed to identify a user action indicating a user desire to view a private data. In one example, the user action includes positioning a user forearm vertically. In one example, the user action includes flipping a user wrist so that the bottom side of the user wrist is facing upwards instead of downwards.

At block 806, the private data is displayed on a display of an arm wearable device responsive to the user action indicating the user desire to view the private data. In one example, the display includes a first display area and a second display area, the first display area arranged to display the private data and the second display area arranged to display a public data.

In one example, the process further includes detecting a proximity of a person to a wearer of the arm wearable device. In this embodiment, the process includes determining whether or where the private data is displayed based on the proximity of the person. In one example, the process further includes determining a location of the arm wearable device. In this embodiment, the process includes determining whether or where data the private data is displayed based on the location of the arm wearable device. In one example, the process further includes authenticating an identity of the user following the user action. For example, the user may be required to enter a password.

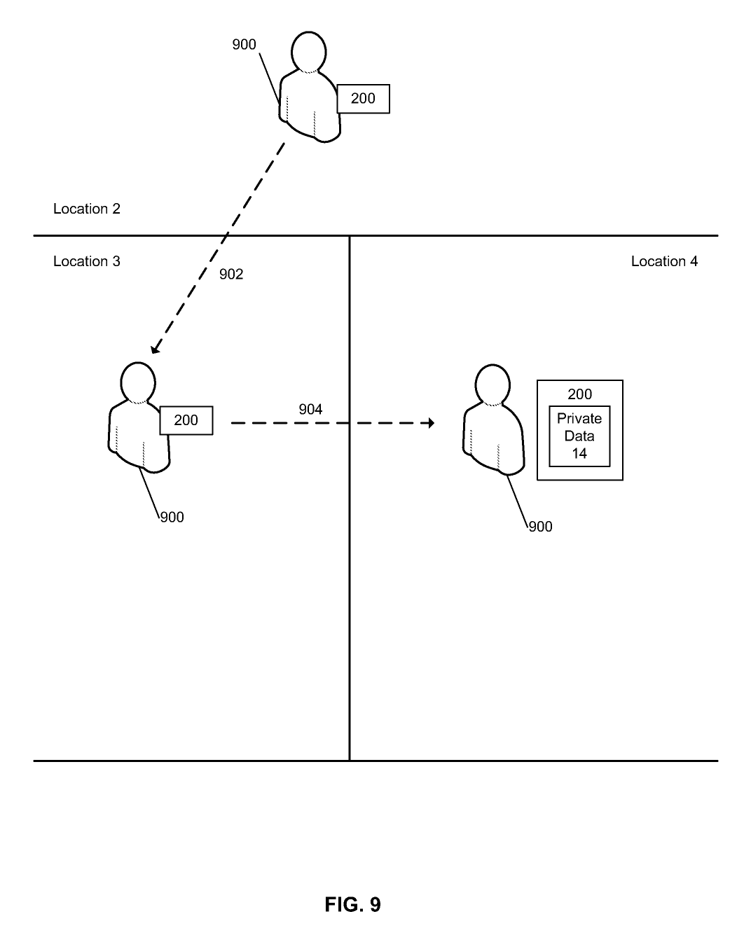

FIG. 9 illustrates a geofencing use scenario of the wrist worn apparatus 200. A location of wrist worn apparatus 200 is determined. Whether or where data is displayed on wrist worn apparatus 200 based on the determined location. Private data may be displayed only when the wrist worn apparatus 200 is currently in an authorized location, otherwise it is suppressed.

In the example shown in FIG. 9, location 4 is an authorized location where private data may be displayed. Location 3 is a public area considered to be unauthorized. At location 2, a user 900 wears a wrist worn apparatus 200. In movement scenario 902, user 900 and wrist worn apparatus 200 move from location 2 to location 3. Upon detection that wrist worn apparatus 200 is at location 3, any display of private data on wrist worn apparatus 200 is suppressed. In movement scenario 904, user 900 and wrist worn apparatus 200 move from location 3 to location 4. Upon detection that wrist worn apparatus 200 is at location 4, any prior or subsequent private data 14 is displayed at wrist worn apparatus 200.

While the exemplary embodiments of the present invention are described and illustrated herein, it will be appreciated that they are merely illustrative and that modifications can be made to these embodiments without departing from the spirit and scope of the invention. For example, methods, techniques, and apparatuses described as applying to one embodiment or example may also be utilized with other embodiments or examples described herein.

Acts described herein may be computer readable and executable instructions that can be implemented by one or more processors and stored on a computer readable memory or articles. The computer readable and executable instructions may include, for example, application programs, program modules, routines and subroutines, a thread of execution, and the like. In some instances, not all acts may be required to be implemented in a methodology described herein.

Terms such as “component”, “module”, “circuit”, and “system” are intended to encompass software, hardware, or a combination of software and hardware. For example, a system or component may be a process, a process executing on a processor, or a processor. Furthermore, a functionality, component or system may be localized on a single device or distributed across several devices. The described subject matter may be implemented as an apparatus, a method, or article of manufacture using standard programming or engineering techniques to produce software, firmware, hardware, or any combination thereof to control one or more computing devices.

Thus, the scope of the invention is intended to be defined only in terms of the following claims as may be amended, with each claim being expressly incorporated into this Description of Specific Embodiments as an embodiment of the invention.

What is claimed is:

1. An arm wearable device comprising:
a first display screen arranged to display private data;
a second display screen arranged to display public data;
a processor; and
a memory comprising an application program executable by the processor, the application program configured to identify a data as a private data type or a public data type, the application program further configured to display the data on the first display screen if the data is the private data type or display the data on the second display screen if the data is the public data type.

2. The arm wearable device of claim 1, further comprising one or more sensors, the one or more sensors comprising a motion sensor to output a motion sensor data.

3. The arm wearable device of claim 2, wherein the application program is further configured to process the motion sensor data to identify a user action indicating a user desire to view a private data, the application program further configured to display the private data at the first display screen responsive to identification of the user desire to view the private data.

4. The arm wearable device of claim 1, further comprising one or more sensors configured to output a sensor data capable of being processed to detect a user wrist or forearm orientation, wherein the application program is further configured to determine whether or where data which is the private data type is displayed based on detection of the user wrist or forearm orientation.

5. The arm wearable device of claim 1, wherein the first display screen is arranged to be worn on a bottom side of a user wrist and the second display screen is arranged to be worn on a top side of the user wrist.

6. An arm wearable device comprising:
a sensor to output a sensor data comprising a motion data or an orientation data;
a display;
a processor; and
a memory comprising an application program executable by the processor, the application program configured to process the sensor data to identify a user action indicating a user desire to view a private data, the application program further configured to display the private data at the display responsive to identification of the user desire to view the private data.

7. The arm wearable device of claim 6, wherein the sensor data is processed to detect a user wrist or forearm orientation.

8. The arm wearable device of claim 6, wherein the user action indicating the user desire to view the private data comprises flipping a user wrist so that a bottom side of the user wrist is facing upwards instead of downwards.

9. The arm wearable device of claim 6, further comprising a proximity detection system to detect a proximity of a person to a wearer of the arm wearable device, wherein the application program is further configured to determine whether or where the private data is displayed based on an output of the proximity detection system.

10. The arm wearable device of claim 6, further comprising a location detection system to determine a location of the arm wearable device, wherein the application program is further configured to determine whether or where data the private data is displayed based on the location of the arm wearable device.

11. The arm wearable device of claim 6, wherein the display comprises a first display area and a second display area, the first display area arranged to display the private data and the second display area arranged to display a public data.

12. A method comprising:
identifying a data as a private data type or a public data type;
outputting the data on an arm wearable device first display responsive to identifying the data as the private data type, the arm wearable device first display arranged to display a private data; and
outputting the data on an arm wearable device second display responsive to identifying the data as the public data type, the arm wearable device second display arranged to display a public data.

13. The method of claim 12, further comprising receiving sensor data from one or more sensors, the one or more sensors comprising a motion sensor to output a motion sensor data.

14. The method of claim 13, further comprising identifying a user action from the motion sensor data indicating a user desire to view a private data, and displaying the private data at the arm wearable device first display responsive to the user desire to view the private data.

15. The method of claim 12, further comprising:
receiving sensor data to detect a user wrist or forearm orientation; and
determining whether or where data which is the private data type is displayed based on detection of the user wrist or forearm orientation.

16. The method of claim 12, further comprising:
detecting a proximity of a person to a wearer of an arm wearable device; and
determining whether or where data which is the private data type is displayed based on the proximity.

17. The method of claim 12, further comprising:
determining a location of an arm wearable device; and
determining whether or where data which is the private data type is displayed based on the location of the arm wearable device.

18. A method comprising:
receiving a sensor data associated with a motion or orientation of a user arm;
processing the sensor data to identify a user action indicating a user desire to view a private data;
displaying the private data on a display of an arm wearable device responsive to the user action indicating the user desire to view the private data.

19. The method of claim 18, wherein the user action comprises positioning a user forearm vertically.

20. The method of claim 18, wherein the user action comprises flipping a user wrist so that a bottom side of the user wrist is facing upwards instead of downwards.

21. The method of claim 18, further comprising authenticating an identity of the user following the user action.

22. The method of claim 18, wherein the display comprises a first display area and a second display area, the first display area arranged to display the private data and the second display area arranged to display a public data.
